(19) United States
(12) Patent Application Publication
(10) Pub. No.: US 2017/0243676 A1
(43) Pub. Date: Aug. 24, 2017

(54) CABLE

(71) Applicant: FOXCONN INTERCONNECT TECHNOLOGY LIMITED, Grand Cayman (KY)

(72) Inventors: A-NAN YANG, Kunshan (CN); HONG-PING WANG, Kunshan (CN); LU-YU CHANG, New Taipei (TW)

(21) Appl. No.: 15/436,847

(22) Filed: Feb. 19, 2017

(30) Foreign Application Priority Data
Feb. 19, 2016 (CN) 201620128941.8

(51) Int. Cl. H01B 9/00; H01B 9/02

(52) U.S. Cl. CPC H01B 9/003; H01B 9/024; H01B 9/006; H01B 9/028

(57) ABSTRACT

A cable (100) includes a power wire (1), a ground wire (3), data transmission wires (2) between the power wire and the ground wire, and an insulating outer layer (4) enclosing the outer side of the power wire, the ground wire, and the data transmission wires. The power wire includes a conductor (11), an insulating layer (12) outside the conductor, and a metal shielding layer (13) outside the insulating layer. The power wire and the data transmission wires are spaced from each other by plastic materials.

### BACKGROUND OF THE INVENTION

### 1. Field of the Invention

The present disclosure relates to wire arrangement of a flat cable.

### 2. Description of Related Arts

Taiwan Patent No. 389916, issued on Oct. 1, 2010, discloses a cable of a flat type structure. The cable includes an outside layer enclosing data transmission wires and power transmission wires. The data transmission wires and the power transmission wires are arranged intimately close to each other.

China Patent No. 204303404, issued on Apr. 29, 2015, discloses a flat wire cable. The flat wire cable includes multiple conductive core wires conforming to Universal Serial Bus (USB) 2.0 specification. Insulation dielectric layers enclose corresponding core wires and wrapping layers enclose corresponding insulation dielectric layers. The flat wire cable further comprises an inner jacket and an outer jacket which sequentially wrap all the core wires.

An improved cable is desired.

### SUMMARY OF THE INVENTION

Accordingly, an object of the present invention is to provide a flat cable with stable structure and good bending capability.

To achieve the above object, a cable includes a power wire, a ground wire, data transmission wires between the power wire and the ground wire, and an insulating outer layer enclosing the power wire, the ground wire, and the data transmission wires. The power wire includes a conductor, an insulating layer outside conductor, and a metal shielding layer outside the insulating layer. The power wire and the data transmission wire are spaced from each other by plastic materials.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of a cable according to a first embodiment of the present invention;

FIG. 2 is an enlarged view of a power wire of the cable in FIG. 1; and

FIG. 3 is an enlarged view of a power wire according to a second embodiment.

### DETAILED DESCRIPTION OF THE PREFERRED EMBODIMENT

Reference will now be made in detail to the preferred embodiment of the present invention.

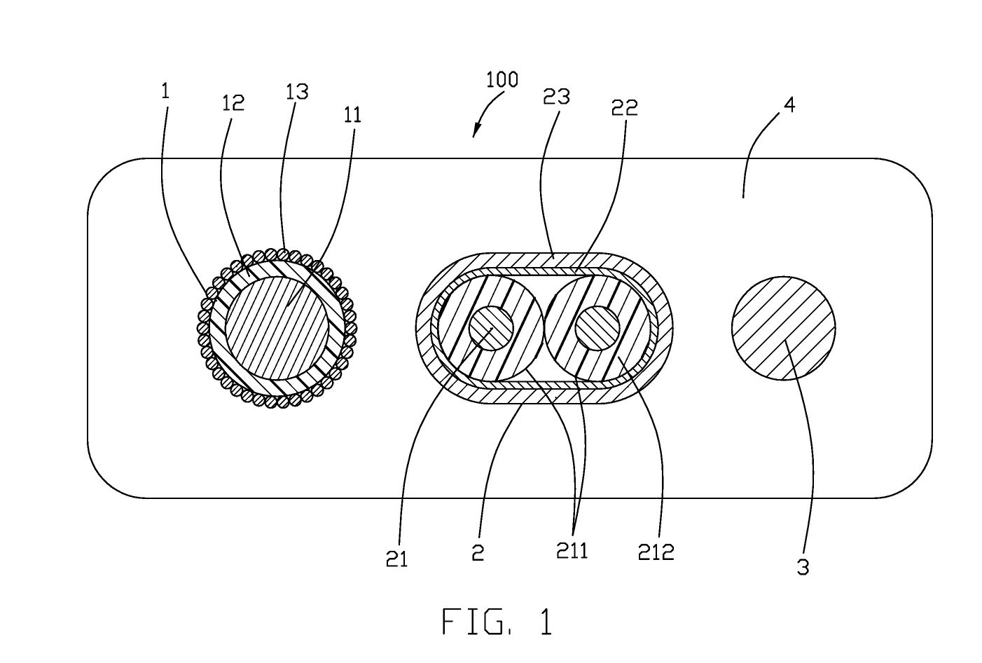

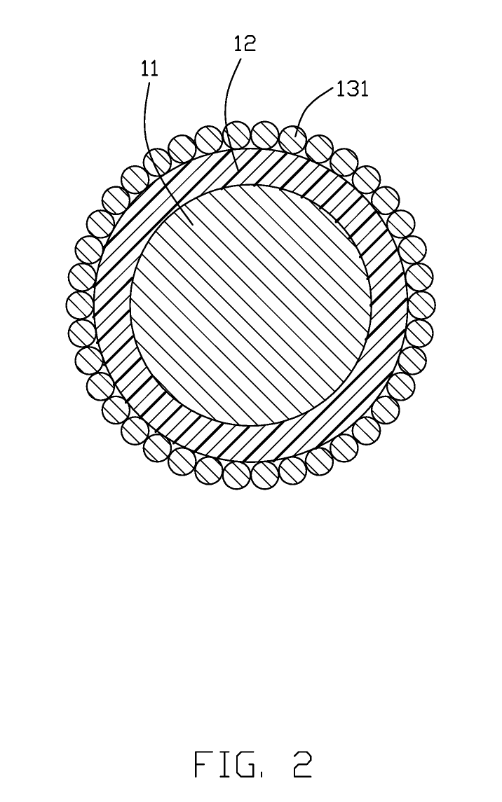

Referring to FIGS. 1 and 2, a cable 100 according to a first embodiment of the present invention is shown. The cable 100 includes a power wire 1, a ground wire 3, data transmission wires 2 between the power wire 1 and the ground wire 3, and an insulating outer layer 4 enclosing the power wire 1, the ground wire 3, and the data transmission wires 2.

The cable 100 is flat and complies with USB 2.0 cable specification.

The power wire 1 includes a conductor 11, an insulating layer 12 coated outside conductor 11, and a metal shielding layer 13 coated outside the insulating layer 12. The power wire 1 and the data transmission wires 2 are filled with plastic materials to improve the bending performance of the cable 100. The metal shield layer 13 of the power wire 1 is a wound metal shield layer 131. The metal shielding layer 13 is used as a ground return with the ground wire 3 and the metal braid layer 23 of the data transmission wires 2, which is beneficial for reducing ground resistance, reducing voltage drop, and realizing fast charging.

The data transmission wires 2 include a pair of differential signal wires 21, an inner shield layer 22 coated on the outer side of the pair of differential signal wires 21, and a metal braid layer 23 coated on the outer side of the inner shield 22. The inner shield layer 22 is an aluminum foil layer. The inner shield 22 is made of aluminum foil or PET (Polyethylene terephthalate) material. Each of the differential signal wires 21 includes a signal conductor 211 and an insulating layer 212 covered on the outside of the signal conductor 211.

The ground wire 3 is a bare conductor. The power wire 3 and the data transmission wires 2 are filled with plastic materials.

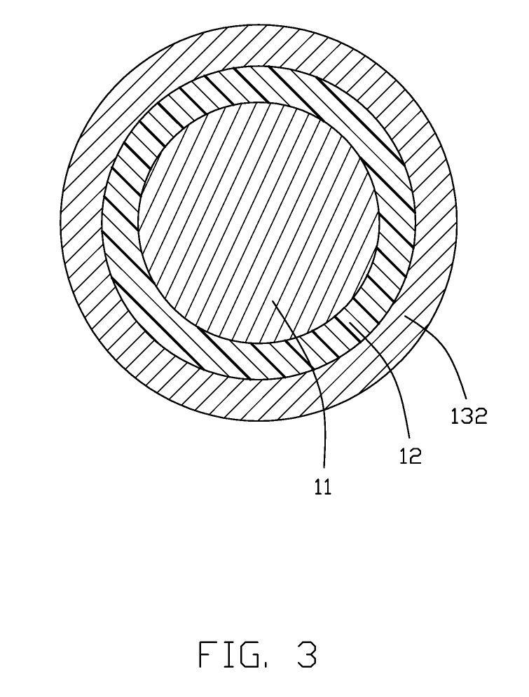

Referring to FIG. 3, a power wire 1 of the cable 100 according to a second embodiment is shown. The metal shield layer 13 of the power wire 1 is a woven metal shield layer 132.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable comprising:
a power wire;
a ground wire;
data transmission wires located between the power wire and the ground wire; and
an insulating outer layer enclosing the power wire, the ground wire, and the data transmission wires; wherein
the power wire includes a conductor, an insulating layer outside the conductor, and a metal shielding layer enclosing the insulating layer; and
the power wire and the data transmission wire are spaced from each other.

2. The cable as claimed in claim 1, wherein the cable is flat.

3. The cable as claimed in claim 1, wherein the ground wire is bare conductor.

4. The cable as claimed in claim 1, wherein the data transmission wires include a pair of differential signal wires, an inner shield layer enclosing the pair of differential signal wires, and a metal braid layer enclosing the inner shield layer.

5. The cable as claimed in claim 4, wherein the inner shield layer is an aluminum foil layer.

6. The cable as claimed in claim 1, wherein the metal shield layer of the power wire has a wound structure.

7. The cable as claimed in claim 1, wherein the metal shield layer of the power wire has a woven structure.

8. A cable comprising:
a power wire used for transmitting power;
a ground wire;
data transmission wires located between the power wire and the ground wire in a transverse direction; and
an insulating outer layer enclosing the power wire, the ground wire, and the data transmission wires; wherein
the power wire includes a conductor, a metal shielding layer surrounding the power wire, and an insulating layer intimately coated therebetween radially; and
the data transmission wires, the power wire and the ground wire are essentially aligned with each other along said transverse direction, and are spaced from one another with corresponding gaps therebetween in said transverse direction.

9. The cable as claimed in claim 8, wherein the ground wire and the data transmission wires are filled with plastic.

10. The cable as claimed in claim 8, wherein the cable is flat.

11. The cable as claimed in claim 8, wherein the ground wire is bare conductor.

12. The cable as claimed in claim 8, wherein the data transmission wires include a pair of differential signal wires, an inner shield layer coated on the outer side of the pair of differential signal wires and a metal braid layer coated on the outer side of the inner shield layer

13. The cable as claimed in claim 8, wherein the inner shield is an aluminum foil layer.

14. The cable as claimed in claim 8, wherein the differential signal wires include signal conductor and an insulating layer covered on the outside of the signal conductor.

15. The cable as claimed in claim 8, wherein the differential signal wires are parallel and close together.

16. The cable as claimed in claim 8, wherein the metal shield layer of the power wire has a wound structure or a woven structure.

17. The cable as claimed in claim 8, wherein the cable is USB 2.0 cable.
